(19) United States
(12) Patent Application Publication
(10) Pub. No.: US 2006/0017820 A1
(43) Pub. Date: Jan. 26, 2006

(54) Digital image device and image management method thereof

(75) Inventor: Su-hyun Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/091,780

(22) Filed: Mar. 29, 2005

(30) Foreign Application Priority Data
Jul. 23, 2004 (KR) 10-2004-0057819

(51) Int. Cl. H04N 5/76

(52) U.S. Cl. 348/231.2

(57) ABSTRACT

A digital image device having an efficient editing function and an image editing method thereof are provided. The image editing method of the digital image device includes: calculating predetermined evaluation scores indicating screen quality of a captured image; and managing the captured image based on the calculated evaluation scores. Accordingly, a user can easily capture and edit images, and wasting of memory can be prevented by deleting the unnecessary images.

### BACKGROUND OF THE INVENTION

This application claims priority from Korean Patent Application No. 10-2004-0057819 filed on Jul. 23, 2004, in the Korean Intellectual Property Office, the disclosure of which is incorporated herein in its entirety by reference.

1. Field of the Invention

The present invention relates to a digital image device, and more particularly, to a digital image device having an efficient management function and an image management method thereof.

2. Description of the Related Art

Recently, the use of consumer electronics (CE) products, such as digital cameras, camera phones, scanners, printers, and all-in-ones, is becoming more popular. Accordingly, demand for clearer digital images having high quality and convenient management of such images is increasing.

However, a conventional digital image device simply provides a focus window, an exposure meter, and a small-sized preview displayer. That is, a user takes an image by manually adjusting an exposure with a simple exposure meter or automatically setting the exposure, adjusting focus through a focus window in a viewfinder, and/or determining a taking time. After taking the image, the user checks screen quality of the image through a small preview displayer and determines whether to retake or store the image.

Also, when the user later edits taken images using a personal computer (PC), the user must confirm hundreds or thousands of stored images one by one and perform filing and editing operations for selecting images having good screen quality and deleting the others.

Furthermore, in digital image devices, most of which are small-sized portable devices, the sizes of preview displayer screens are small, and screen quality of images displayed under bright outdoor lighting is deteriorated. Accordingly, it is difficult to exactly determine screen quality of taken images. Also, since all images including the same objects repeatedly taken several times are stored until the images are edited and filed, memory is wasted. In particular, when a small-sized portable device having a limited memory is used during a long period of travel, memory can run out.

### SUMMARY OF THE INVENTION

The present invention provides a digital image device having an efficient management function and an image management method thereof.

According to an aspect of the present invention, there is provided an image management method of a digital image device, the method comprising: calculating predetermined evaluation scores indicating screen quality of a captured image; and managing the captured image based on the calculated evaluation scores.

In the calculating of the predetermined evaluation scores, evaluation scores according to at least one of a plurality of predetermined standards indicating the screen quality of the captured image may be calculated.

In the calculating of the predetermined evaluation scores, a total score may be calculated by converting the evaluation scores.

The predetermined standards may include at least one of brightness, contrast, color and exposure.

The managing of the captured image may comprise: displaying the calculated evaluation scores to a user along with the captured image; and capturing an image again from the beginning if the user wishes to retake the image in response to the displayed evaluation scores, and storing the captured image and the calculated evaluation scores if the user does not wish to retake the image.

In the displaying of the calculated evaluation scores, an alarm for informing the user that it is necessary for the image to be retaken may be displayed if the calculated evaluation scores are less than predetermined thresholds.

The alarm may be indicated with text or sound.

The managing of the captured image may comprise: sorting at least one of a plurality of images stored on the basis of calculated evaluation scores; displaying the sorted images and their associated evaluation scores; and selecting and deleting images having values less than a predetermined threshold desired by the user among the sorted images.

The managing of the captured image may comprise: sorting at least one of a plurality of images stored on the basis of calculated evaluation scores; displaying the sorted images and their associated evaluation scores; and searching and deleting images having values less than a predetermined threshold pre-set in the digital image device among the sorted images.

In the sorting of the plurality of images the plurality of images may be sorted by gathering similar images and giving priority to them based on their evaluation scores.

According to another aspect of the present invention, there is provided a digital image device comprising: a calculator calculating predetermined evaluation scores based on screen quality of a captured image; and an image management unit managing the captured image based on the evaluation scores calculated by the calculator.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a digital image device according to an exemplary embodiment of the present invention;

FIG. 2 is a flowchart illustrating a method of capturing an image in a digital image device according to an exemplary embodiment of the present invention;

FIG. 3 is a flowchart illustrating a method of editing an image in a digital image device according to an exemplary embodiment of the present invention;

FIG. 4 illustrates the image capturing method applied to a digital camera according to an exemplary embodiment of the present invention;

FIG. 5 illustrates the image editing method applied to a PC according to an exemplary embodiment of the present invention;

FIG. 6 illustrates a process of calculating evaluation scores according to an exemplary embodiment of the present invention;

FIGS. 7A through 7D are an example of histograms for illustrating standards used to calculate evaluation scores according to an exemplary embodiment of the present invention; and

FIGS. 8A through 8D illustrate a correlation between an image and histograms in an evaluation score calculating method according to an exemplary embodiment of the present invention.

### DETAILED DESCRIPTION OF THE EXEMPLARY EMBODIMENTS

Hereinafter, exemplary embodiments of the present invention will now be described more fully with reference to the accompanying drawings.

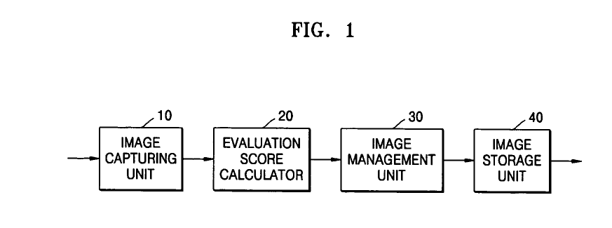

FIG. 1 is a block diagram of a digital image device according to an exemplary embodiment of the present invention.

Referring to FIG. 1, the digital image device includes an image capturing unit 10, an evaluation score calculator 20, an image management unit 30, and an image storage unit 40.

The image capturing unit 10 takes an image and captures the image. The captured image is transmitted to the evaluation score calculator 20.

The evaluation score calculator 20 calculates evaluation scores for evaluating screen quality of the transmitted image on the basis of predetermined evaluation standards. For example, at least one of brightness information, contrast information, color information, focus information, and exposure information of the captured image can be used for the evaluation standard. A method of calculating evaluation scores will be described in detail later.

The image management unit 30 manages captured images based on calculated evaluation scores. That is, when an image is taken, the image management unit 30 displays calculated evaluation scores to a user, and if the calculated evaluation scores are less than predetermined thresholds, the image management unit 30 informs the user that the image should be retaken.

Also, the image management unit 30 helps the user determine whether the image should be retaken by displaying the calculated evaluation scores to the user along with a captured image. That is, after seeing the displayed evaluation score, the user can retake the image if the displayed evaluation scores are less than the predetermined thresholds. In this case, a new image is captured again from the beginning. If the user is satisfied with the displayed evaluation score, the image management unit 30 stores the captured image in the image storage unit 40. In order to help a user make a decision, the image management unit 30 can display an alarm for informing the user that it is necessary for the image to be retaken when the evaluation scores are less than pre-set thresholds. That is, the image management unit 30 informs the user that it is necessary for the image to be retaken using text or sound.

The image management unit 30 sorts a plurality of stored images based on evaluation scores and displays the sorted images to the user along with their associated evaluation scores. The user can manually select and delete images having values less than a threshold determined by the user. Also, images having values less than a predetermined threshold pre-set in the digital image device can be automatically searched and deleted. Here, the image management unit 30 can sort the plurality of stored images by gathering images equal or similar to each other and giving them priority.

As described above, when the user is satisfied with displayed evaluation scores, or when evaluation scores of captured images are greater than a predetermined threshold, the image management unit 30 stores their associated images in the image storage unit 40.

An image management method according to an exemplary embodiment of the present invention will now be described on the basis of the configuration of the digital image device described above. In particular, the image management method will be divided into a method of capturing an image and a method of editing the captured image, and the two methods will be described.

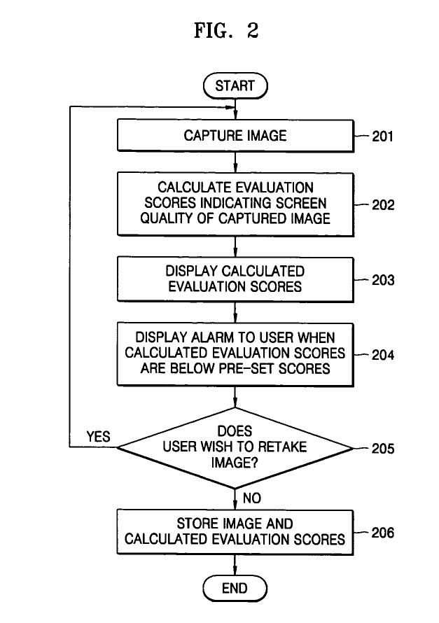

FIG. 2 is a flowchart illustrating a method of capturing an image in a digital image device according to an exemplary embodiment of the present invention.

Referring to FIG. 2, a method of capturing an image so as to obtain images having optimal screen quality in a digital image device, such as a digital camera or a camera phone, which captures and stores images is illustrated.

In operation 201, an image is captured or an image captured by another digital image device is transmitted. Evaluation scores for evaluating screen quality of the captured image are calculated in operation 202. Evaluation scores corresponding to standards such as focus, brightness, contrast, and exposure are calculated to evaluate the screen quality of the captured image. In this case, an evaluation score for each standard can be calculated using a standardized database. A detailed method of calculating evaluation scores will be described later. Also, a total score can be calculated by converting the calculated evaluation score for each standard on the basis of a predetermined weight. The calculated evaluation scores and the captured image are displayed on a screen in operation 203. If the evaluation scores are less than predetermined thresholds, an alarm message may be displayed so that a user retakes the image in operation 204. The alarm message can be provided using text or sound. The displaying of the alarm message in operation 204 is an option. If the user wishes to retake the image in operation 205, this process is performed again from operation 201. If the user is satisfied with the displayed evaluation scores and displayed image or does not wish to make a decision, that is, if the user does not wish to retake the image in operation 205, the displayed evaluation scores and image are stored in the image storage unit 40 in operation 206. Thus, the user can easily and quickly determine whether to retake an image using evaluation scores displayed on a screen or using an alarm.

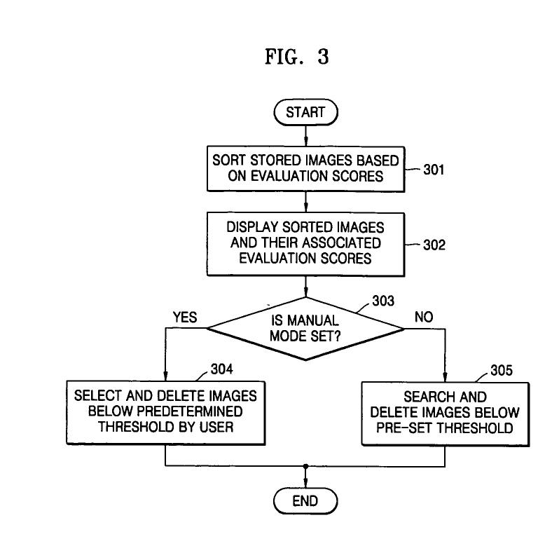

FIG. 3 is a flowchart illustrating a method of editing an image in a digital image device according to an exemplary embodiment of the present invention.

Referring to FIG. 3, illustrated is a method of conveniently performing editing work such as an image storing or deleting by sorting images based on screen quality using calculated evaluation scores when captured images are edited in a digital image device, such as a digital camera or a camera phone, or in a PC using digital image editing software.

In an editing mode, a plurality of stored images are sorted on the basis of evaluation scores in operation 301. The sorted images and their associated evaluation scores are displayed on a screen together in operation 302. If a manual mode is selected in operation 303, a user can select and delete images having values less than a predetermined threshold desired by the user among the sorted images in operation 304. If the manual mode is not selected in operation 303, images having values less than a predetermined threshold pre-set in the digital image device can be automatically searched and deleted in operation 305. Here, in order to let a user undo a mistake, the images may be temporarily deleted, similar to a trash can function of Microsoft Windows, and after obtaining the user's confirmation, the images may be completely deleted.

Accordingly, the wasting of memory space due to storing of unnecessary images having low screen quality can be prevented. Also, the inconvenience of conventional technology, in which the user confirms images one by one, determines whether each image is deleted, and deletes the images one by one, can be resolved.

Furthermore, when a plurality of similar images exist after the user having taken the same image several times, the image editing method helps the user easily select an image having the highest screen quality by sorting similar images, giving priority to the images on the basis their associated evaluation scores, and displaying the results on the screen.

Examples to which the image capturing method and the image editing method according to exemplary embodiments of the present invention are applied will now be described.

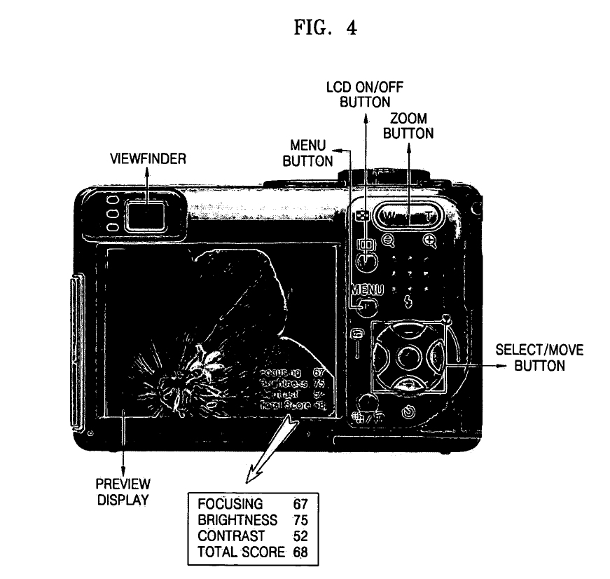

FIG. 4 illustrates the image capturing method applied to a digital camera according to an exemplary embodiment of the present invention.

Referring to FIG. 4, a captured image and its evaluation scores are displayed on a screen. That is, as soon as an image is taken, evaluation scores are calculated by analyzing a captured image according to the method described below. In this embodiment, an example in which focus, brightness, and contrast are used as evaluation standards is illustrated. Also, a total score obtained by weighting evaluation standards with predetermined values and converting the weighted evaluation standards is displayed. When an image is taken, a user can confirm evaluation scores and/or a total score displayed along with a captured image. Thus, a user can easily and quickly determine whether the captured image satisfies desired screen quality, and a user can determine whether the image should be retaken without storing of the captured image, or whether the image should be stored according to the determination result. Therefore, evaluation scores displayed along with a captured image can help the user make a decision.

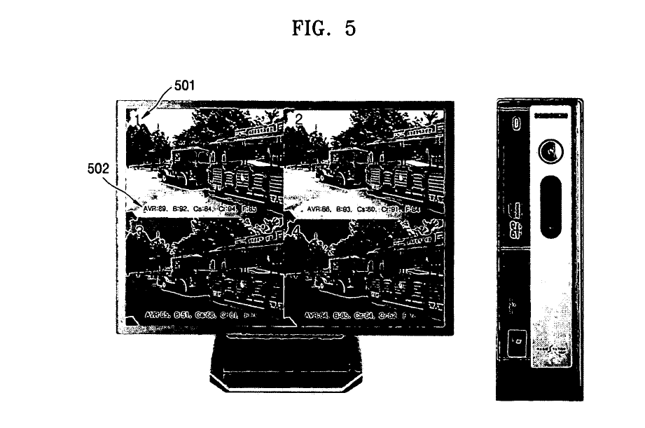

FIG. 5 illustrates an image editing method applied to a PC according to an exemplary embodiment of the present invention.

Referring to FIG. 5, a method of easily editing and sorting stored images in a PC is illustrated. Priority of a plurality of stored images is determined according to screen quality based on evaluation scores, and the stored images are displayed on a screen according to the priority. In the case of a picture, evaluation scores calculated on the basis of brightness, contrast, color, and focus are displayed, and a mean value of the evaluation scores are displayed as a total score as shown by reference number 502. Also, the priority according to the total score is displayed as shown by reference number 501. A user can easily select files to be deleted or stored since the user can determine screen quality of the stored images at a glance through the priority. In particular, as shown in FIG. 5, when similar images are repeatedly stored, wasting of memory can be prevented by deleting all images except an image having a screen quality of high priority.

Also, the user can manually select and delete images below a desired total score or priority at once. Alternatively, images having total scores or priority below a predetermined threshold pre-set in a digital image device are automatically searched and deleted at once. Here, in order to reduce a user's mistakes, the selected images may be temporarily moved to a trash can, and after confirmation by the user, the images may be completely deleted.

As described above, a digital image device according to the present exemplary embodiment provides a function helping a user capture images and sort and edit the captured images using evaluation scores.

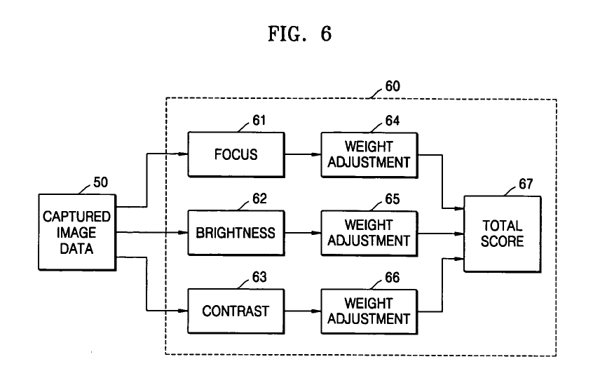

FIG. 6 illustrates a process of calculating evaluation scores according to an exemplary embodiment of the present invention.

Referring to FIG. 6, a process of calculating evaluation scores according to evaluation standards, such as focus, brightness, and contrast, from image data captured by an evaluation score calculator 60 is illustrated. A total score can be calculated by weighting each evaluation score with a predetermined value.

An evaluation score calculating method will now be described in detail.

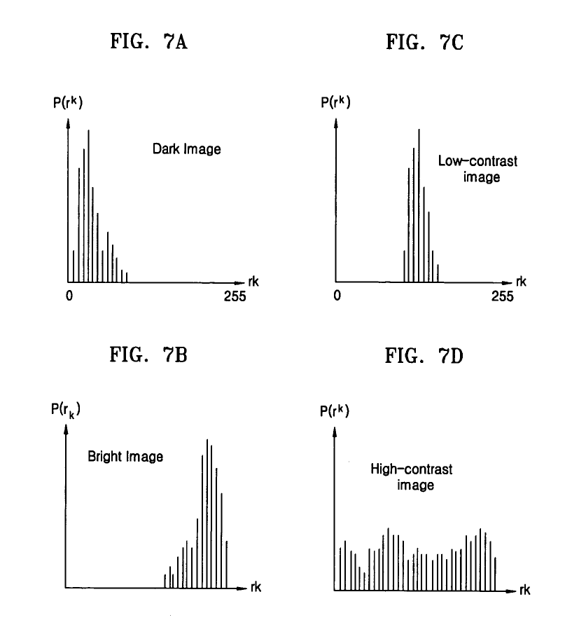

FIGS. 7A through 7D are examples of histograms for illustrating standards used to calculate evaluation scores according to an exemplary embodiment of the present invention.

Referring to FIGS. 7A through 7D, brightness and contrast, which are important evaluation standards used to indicate screen quality of images are illustrated. In general, the brightness and contrast of an image are normalized and expressed with level values between 0 and 255. As shown in FIGS. 7A and 7B, when brightness level values of pixels of an image are near 0, the image is darker, and when brightness level values of pixels of an image is near to 255, the image is brighter. Also, as shown in FIGS. 7C and 7D, when contrast level values of pixels of an image are widely distributed between 0 and 255, the image has a high contrast, and when contrast level values of pixels of an image are narrowly distributed between 0 and 255, the image has a low contrast. In FIGS. 7A through 7D, P denotes a probability and rk denotes a level value of each pixel. An image type according to a histogram pattern can be obtained using a distribution state of level values of pixels included in an image.

Therefore, after a captured image is converted to gray-scale values, information of brightness and contrast (clearness) of the captured image can be determined by checking histograms in which level values of every pixel are expressed. Various algorithms can be used to calculate evaluation scores by evaluating the histograms. In the embodiment described below, an example in which evaluation scores are simply calculated using patterns of a gray-scale image will be described.

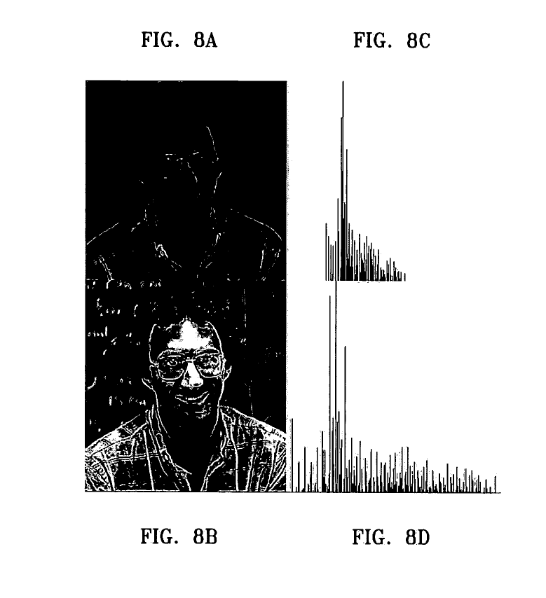

FIGS. 8A through 8D illustrate a correlation between an image and histograms in an evaluation score calculating method according to an exemplary embodiment of the present invention.

Referring to FIGS. 8A through 8D, in a case of a low-contrast image shown in FIG. 8A, a histogram distribution state is narrow as shown in FIG. 8C, and in a case of a high-contrast image shown in FIG. 8B, a histogram distribution state is wide as shown in FIG. 8D. It can be determined which type of distribution an image has by calculating a deviation based on the image.

Hereinafter, F denotes focus, B denotes brightness, C denotes contrast, Rave denotes a mean level of all the pixels of an image frame (0≦Rave≦255), σ denotes a standard deviation, Rₘ denotes a proper mean level set by a manufacturer, σₘ denotes a proper deviation set by a manufacturer, E denotes an edge frequency of an image, Eₘ denotes a proper edge frequency set by a manufacturer, Pb denotes a bright penalty constant, Pc denotes a contrast penalty constant, Pf denotes a focus (sharpness) penalty constant, and Tₛ denotes a total score.

In more detail, Equation 1 can be used to calculate an evaluation score of brightness.

$$Rave = \frac{{\sum }_{rk = 0}^{255} rk * P ( rk )}{{\sum }_{rk = 0}^{255} P ( rk )} \qquad [ Equation 1 ]$$

Also, Equation 2 can be used to calculate an evaluation score of contrast (clearness).

$$σ = \sqrt{\frac{{\sum }_{rk = 0}^{255} {( rk - Rave )}^{2}}{{\sum }_{rk = 0}^{255} P ( rk )}} \qquad [ Equation 2 ]$$

In general, since proper brightness, contrast, and distribution of high-quality images are determined according to settings of digital image devices set by manufacturers and images to be taken, thresholds can be set by the manufacturers using an experimental method. The set of values can be managed with a database. For example, in the histograms of FIGS. 7A through 7D, If experimental data, in which an image is a bright image when the Rave of the brightness of the image is larger than 127, i.e., an intermediate value, and the optimal brightness is between 120 and 150, is obtained, an evaluation score of brightness of an image can be calculated by giving the image a predetermined penalty when the Rave of the image is out of the range between 120 and 150. Also, an evaluation score of contrast of an image can be calculated by experimentally determining an optimal contrast range using the standard deviation σ obtained by Equation 2 and giving the image a predetermined penalty when the Rave of the contrast of the image is out of the range.

In detail, each evaluation score based on each evaluation standard can be normalized with a value between 0 and 100 as shown in Equations 3 and 4.
B=100−Pb*|Rave−Rₘ| (0≦B≦100) [Equation 3]
C=100−Pc*|σ−σₘ| (0≦C≦100) [Equation 4]

Like B and C, focus also can be normalized with a value between 0 and 100 using an edge detection algorithm or a sharpness filter algorithm as shown in Equation 5.
F=100−Pf*|E−Eₘ| (0≦F≦100) [Equation 5]

A total score can be calculated using B, C, and F calculated by Equations 3, 4, and 5 so that a user can evaluate the screen quality of an image at a glance as shown in Equation 6.

$${T}_{S} = \frac{( a * F ) + ( b * F ) + ( c * C )}{a + b + c} ( 0 \leq {T}_{S} \leq 100 ) \qquad [ Equation 6 ]$$

Here, a, b, and c are weights that can be adjusted by the user, 0.5≦a,b,c≦1.5, and initial values of a, b, and c are preferably 1.

Low-quality images below thresholds pre-set by a manufacturer or a user can be easily deleted by comparing evaluation values, such as B, C, F, and Tₛ, with the thresholds. As described above, various combination of B, C, F, and Tₛ can be used.

The evaluation score calculating method described above is only one exemplary embodiment, and evaluation scores for evaluating screen quality of images can be calculated using other algorithms. Also, besides brightness, contrast, and focus, various elements for evaluating screen quality of images can be further added.

As described above, according to embodiments of the present invention, a digital image device having an efficient editing function and an image editing method thereof are provided.

Thus, a user can conveniently and quickly obtain high quality images by calculating evaluation scores for evaluating screen quality of captured images and displaying the captured images to the user. If necessary, the user can obtain better images by retaking images.

Also, in a process of sorting and editing stored images, the user can store optimal images by sorting and displaying images based on evaluation scores and easily delete unnecessary images having a screen quality below a threshold.

Accordingly, the user can easily capture and edit images, and wasting of memory can be prevented by deleting the unnecessary images.

Furthermore, problems are solved, such as the difficulty of exactly determining the screen quality of taken images since the sizes of screens of LCD displayers of digital image devices, such as digital cameras and camera phones, are small and, further, the screen quality of images displayed under bright outdoor lighting is not clear. Also, a helper function for helping a user make a decision is provided.

While aspects of the present invention have been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An image management method of a digital image device, the method comprising:
calculating evaluation scores indicating a screen quality of a captured image; and
managing the captured image based on the evaluation scores which have been calculated.

2. The method of claim 1, wherein in the calculating of the evaluation scores, evaluation scores according to at least one of a plurality of predetermined standards indicating the screen quality of the captured image are calculated.

3. The method of claim 2, wherein in the calculating of the evaluation scores, a total score is calculated by converting the evaluation scores.

4. The method of claim 2, wherein the predetermined standards comprise at least one of brightness, contrast, color and exposure.

5. The method of claim 1, wherein the managing of the captured image comprises:
displaying the evaluation scores which have been calculated to a user together with the captured image; and
capturing an image again if the user wishes to retake an image in response to the evaluation scores which are displayed, and storing the captured image and the evaluation scores which have been calculated if the user does not wish to retake the image.

6. The method of claim 5, wherein in the displaying of the evaluation scores which have been calculated, an alarm for informing the user that it is necessary for the image to be retaken is displayed if the evaluation scores which have been calculated are less than predetermined thresholds.

7. The method of claim 6, wherein the alarm is indicated with text or sound.

8. The method of claim 1, wherein the managing of the captured image comprises:
sorting at least one of a plurality of images stored on the basis of evaluation scores which have been calculated;
displaying the images which have been sorted and their associated evaluation scores; and
selecting and deleting images having values less than a predetermined threshold desired by the user among the images which have been sorted.

9. The method of claim 1, wherein the managing of the captured image comprises:
sorting at least one of a plurality of images stored on the basis of evaluation scores which have been calculated;
displaying the images which have been sorted and their associated evaluation scores; and
searching and deleting images having values less than a predetermined threshold pre-set in the digital image device among the images which have been sorted.

10. The method of claim 8, wherein in the sorting of the plurality of images, the plurality of images are sorted by gathering similar images and assigning priority to the images which have been sorted based on evaluation scores.

11. The method of claim 9, wherein in the sorting of the plurality of images, the plurality of images are sorted by gathering similar images and assigning priority to the images based on their evaluation scores.

12. A digital image device comprising:
a calculator which calculates evaluation scores based on a screen quality of a captured image; and
an image management unit which manages the captured image based on the evaluation scores which have been calculated by the calculator.

13. The digital image device of claim 12, wherein the calculator calculates the evaluation scores according to at least one of a plurality of predetermined standards indicating the screen quality of the captured image.

14. The digital image device of claim 13, wherein the calculator calculates a total score by converting the evaluation scores.

15. The digital image device of claim 13, wherein the predetermined standards include at least one of brightness, contrast, color and exposure.

16. The digital image device of claim 12, wherein the image management unit displays the evaluation scores which have been calculated to a user along with the captured image, controls the device to capture an image again if the user wishes to retake the image in response to the evaluation scores which are displayed, and stores the captured image and the evaluation scores which have been calculated if the user does not wish to retake the image.

17. The digital image device of claim 16, wherein the image management unit displays an alarm for informing the user that it is necessary for the image to be retaken if the evaluation scores which have been calculated are less than predetermined thresholds.

18. The digital image device of claim 17, wherein the alarm is indicated with text or sound.

19. The digital image device of claim 12, wherein the image management unit sorts at least one of a plurality of images stored on the basis of evaluation scores which have been calculated, displays the images which have been sorted and the evaluation scores, and selects and deletes images having values less than a predetermined threshold desired by the user among the images which have been sorted.

20. The digital image device of claim 12, wherein the image management unit sorts at least one of a plurality of images stored on the basis of evaluation scores which have been calculated, displays the images which have been sorted and the evaluation scores, and searches and deletes images having values less than a predetermined threshold pre-set in the digital image device among the images which have been sorted.

21. The digital image device of claim 19, wherein the image management unit sorts the images by gathering similar images and assigning priority to the images based on the evaluation scores.

22. The digital image device of claim 20, wherein the image management unit sorts the images by gathering similar images and assigning priority to the images based on the evaluation scores.
